(19) United States
(12) Patent Application Publication
(10) Pub. No.: US 2016/0232346 A1
(43) Pub. Date: Aug. 11, 2016

(54) MECHANISM FOR TRACKING TAINTED DATA

(71) Applicant: QUALCOMM Incorporated, San Diego, CA (US)

(72) Inventors: Michael William Paddon, Tokyo (JP); Matthew Christian Duggan, Tokyo (JP); Craig Brown, Harbord (AU); Kento Tarui, Tokyo (JP)

(21) Appl. No.: 14/615,321

(22) Filed: Feb. 5, 2015

(51) Int. Cl. G06F 21/55; G06F 21/60

(52) U.S. Cl. CPC G06F 21/552; G06F 21/60; G06F 2221/034

(57) ABSTRACT

The disclosure relates in some aspects to protecting systems and data from maliciously caused destruction. Data integrity is maintained by monitoring data to detect and prevent potential attacks. A mechanism for tracking whether data is tainted is implemented in a Data Flow computer architecture or some other suitable architecture. In some aspects, a taint checking mechanism is implemented within a register file, memory management, and an instruction set of such an architecture. To this end, an indication of whether the data stored in a given physical memory location is tainted is stored along with the physical memory location. For example, a register can include a bit for a corresponding taint flag, a memory page can include a bit for a corresponding taint flag, and an input/output (I/O) port can include a bit for a corresponding taint flag.

### BACKGROUND

1. Field of the Disclosure

Aspects of the disclosure relate generally to data management, and more specifically, but not exclusively, to tracking tainted data.

2. Description of Related Art

In computer architectures, there is a need to ensure that data used by a computer is not compromised (e.g., by a hacker, a malicious program, etc.). Data to be protected includes data stored in memory and registers.

A Data Flow computer architecture such as an EDGE (Explicit Data Graph Execution) architecture may explicitly encode data dependencies between operations in machine instructions. EDGE architectures (such as Microsoft® E2) group instructions into execution blocks of (for example) up to 128 instructions. Stores and loads from registers are typically used to communicate values between different execution blocks.

There is a large class of security vulnerability which is typified by trusting incorrectly vetted external inputs, allowing attackers to access unintended functionality. Taint tracking is a known technique for dynamically catching instances of untrusted data, regardless of the path of the untrusted data through the code. Conventionally, taint tracking is run off-line, e.g., during simulations.

### SUMMARY

The following presents a simplified summary of some aspects of the disclosure to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present various concepts of some aspects of the disclosure in a simplified form as a prelude to the more detailed description that is presented later.

Various aspects of the present disclosure provide mechanisms for tracking whether data is tainted. In some aspects the mechanisms are implemented in a Data Flow computer architecture (e.g., an EDGE architecture). In some aspects, a taint checking mechanism is implemented with a register file, memory management, and an instruction set of such an architecture.

An indication of whether the data stored in a given physical memory location is tainted is stored along with the physical memory location. For example, taint bits may be associated with registers, memory pages and I/O ports. As a more specific, but non-exclusive example, a register can include a bit for a corresponding taint flag, a memory page can include a bit for a corresponding taint flag, and an input/output (I/O) port can include a bit for a corresponding taint flag.

Through the use of these taint flags, an indication of whether data (or other data derived from that data) is tainted can follow the data (or the derived data) through the instruction execution flow for a computer. To this end, whenever tainted data is stored in a physical memory location, a corresponding taint flag is set for the physical memory location. Conversely, whenever data is read from a physical memory location, a check is performed to determine whether the data is tainted. In practice, a single taint flag could be used to indicate tainted data for a page of physical memory locations.

A critical execution operation (e.g., a system call) may thus readily determine whether tainted data is being passed to the operation. If so, the operation may raise an exception to prevent the tainted data from corrupting the operation.

In one aspect, the disclosure provides a method for data management including receiving first data from a first physical memory location; determining whether the first data is tainted, wherein the determination is based on a first indication stored for the first physical memory location; storing second data based on the first data in a second physical memory location; and storing a second indication for the second physical memory location, wherein the second indication indicates whether the second data is tainted.

Another aspect of the disclosure provides an apparatus configured for data management including at least one memory circuit and a processing circuit coupled to the at least one memory circuit. The processing circuit is configured to: receive first data from a first physical memory location of the at least one memory circuit; determine whether the first data is tainted, wherein the determination is based on a first indication stored for the first physical memory location; store second data based on the first data in a second physical memory location of the at least one memory circuit; and store a second indication for the second physical memory location, wherein the second indication indicates whether the second data is tainted.

Another aspect of the disclosure provides an apparatus configured for data management. The apparatus including means for receiving first data from a first physical memory location; means for determining whether the first data is tainted, wherein the determination is based on a first indication stored for the first physical memory location; means for storing second data based on the first data in a second physical memory location; and means for storing a second indication for the second physical memory location, wherein the second indication indicates whether the second data is tainted.

Another aspect of the disclosure provides a computer readable medium storing computer executable code, including code to receive first data from a first physical memory location; determine whether the first data is tainted, wherein the determination is based on a first indication stored for the first physical memory location; store second data based on the first data in a second physical memory location; and store a second indication for the second physical memory location, wherein the second indication indicates whether the second data is tainted.

These and other aspects of the disclosure will become more fully understood upon a review of the detailed description, which follows. Other aspects, features, and implementations of the disclosure will become apparent to those of ordinary skill in the art, upon reviewing the following description of specific implementations of the disclosure in conjunction with the accompanying figures. While features of the disclosure may be discussed relative to certain implementations and figures below, all implementations of the disclosure can include one or more of the advantageous features discussed herein. In other words, while one or more implementations may be discussed as having certain advantageous features, one or more of such features may also be used in accordance with the various implementations of the disclosure discussed herein. In similar fashion, while certain implementations may be discussed below as device, system, or method implementations it should be understood that such implementations can be implemented in various devices, systems, and methods.

### BRIEF DESCRIPTION OF THE DRAWINGS

FIG. 1 illustrates certain aspects of a Data Flow computer architecture in which one or more aspects of the disclosure may find application.

FIG. 2 illustrates an example of instruction execution in a Data Flow computer architecture in which one or more aspects of the disclosure may find application.

FIG. 3 illustrates another example of instruction execution in a Data Flow computer architecture in which one or more aspects of the disclosure may find application.

FIG. 4 illustrates an example of computer architecture in accordance with some aspects of the disclosure.

FIG. 5 illustrates an example of flagging data as tainted in accordance with some aspects of the disclosure.

FIG. 6 illustrates an example of tracing tainted data in accordance with some aspects of the disclosure.

FIG. 7 illustrates an example of a taint tracking process in accordance with some aspects of the disclosure.

FIG. 8 illustrates an example of exception handling in accordance with some aspects of the disclosure.

FIG. 9 illustrates an example of process for clearing a taint flag in accordance with some aspects of the disclosure.

FIG. 10 illustrates a block diagram of an example hardware implementation for an electronic device that supports data tracking in accordance with some aspects of the disclosure.

FIG. 11 illustrates an example of a data tracking process in accordance with some aspects of the disclosure.

FIG. 12 illustrates an example of additional aspects of the data tracking process of FIG. 11 in accordance with some aspects of the disclosure.

FIG. 13 illustrates an example of additional aspects of the data tracking process of FIG. 11 in accordance with some aspects of the disclosure.

FIG. 14 illustrates an example of additional aspects of the data tracking process of FIG. 11 in accordance with some aspects of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

The disclosure relates in some aspects to tracking values which come from potentially untrusted sources (e.g., external sources), as the values are manipulated by a program. Safe and unsafe data sources and sinks may be defined by marking memory pages and registers appropriately. For example, each storage location that stores data from an untrusted source (e.g., from an I/O device) is flagged as tainted. This flagging continues as the data is passed from one instruction or operation to another. Thus, the storage location of any instance of the data throughout the execution process will be marked as tainted.

Any attempt to use a tainted value in an unsafe way generates an exception condition that interrupts execution flow. For instance, a kernel can ensure that only untainted values are passed to system calls by requiring parameters to be passed in untainted memory pages or registers.

For purposes of illustration, various aspects of the disclosure will be described in the context of a Data Flow computer architecture (e.g., an EDGE architecture). It should be understood, however, that the teachings herein are not limited to such an implementation and that the teachings herein could be used in other computer architectures.

### Data Flow Architecture

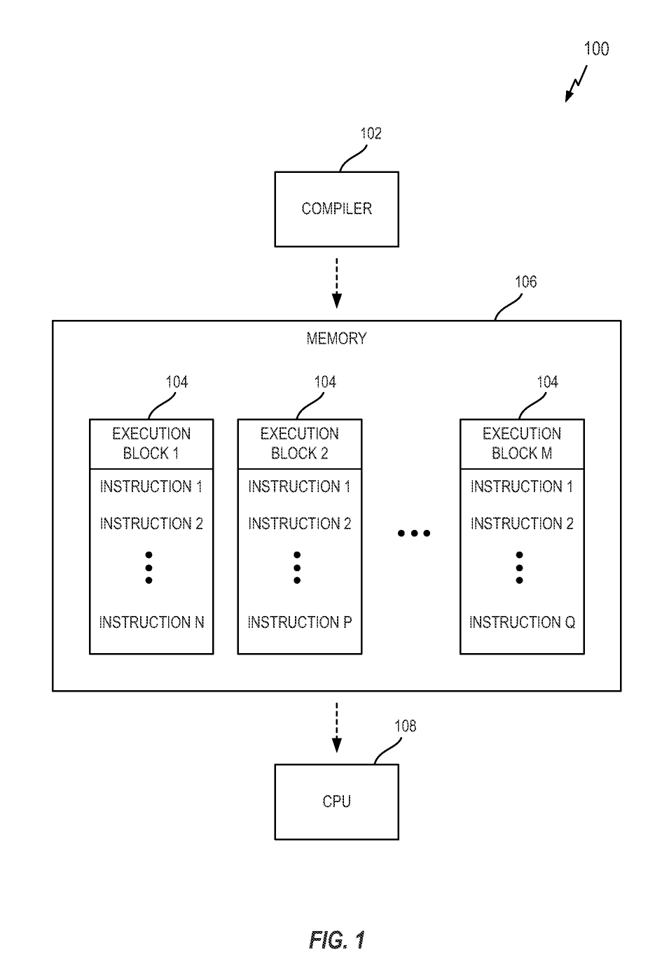

FIG. 1 is a simplified example of a Data Flow computer architecture 100 where a compiler 102 compiles code into sets of execution blocks 104 that are stored in a memory 106 for execution by a central processing unit (CPU) 108. As indicated, each execution block includes several instructions. For example, an EDGE architecture may group instructions into execution blocks of 128 instructions or more.

A Data Flow computer architecture executes instructions in parallel whereby a given instruction is executed whenever the inputs for the instruction are ready. In an actual system, a Data Flow computer architecture may support a large number of parallel executions (e.g., a hundred, or more). Through the use of such an architecture, improvements in processing efficiency may be achieved, thereby improving system performance and/or reducing system power consumption.

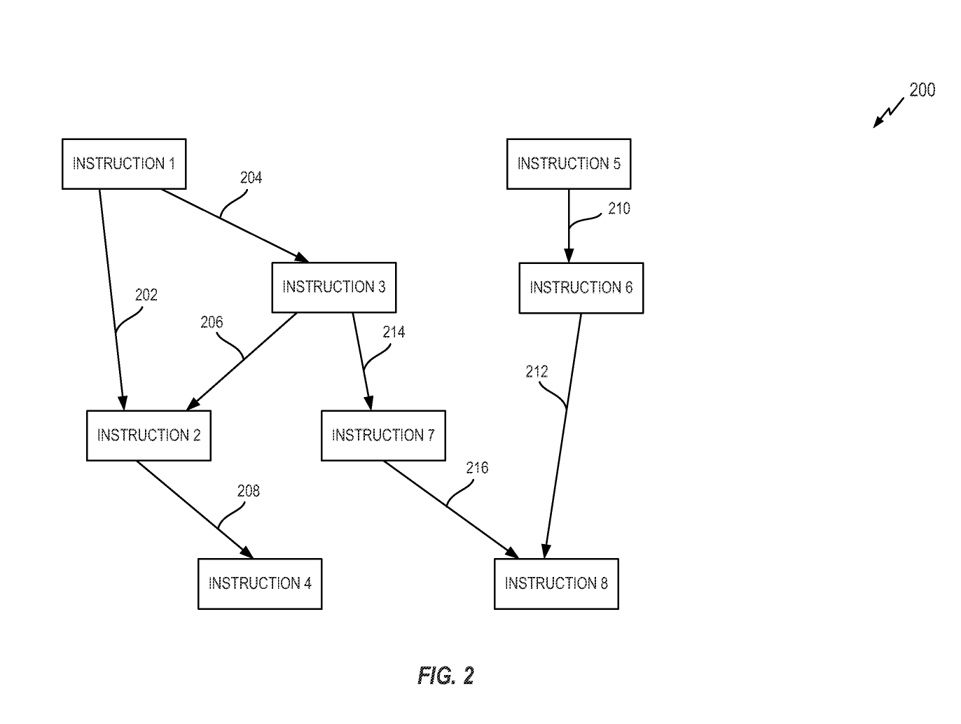

FIG. 2 illustrates simplified execution tree 200 that illustrates that instructions are executed whenever their respective inputs (e.g., operands) are ready. In this example, instruction 1 provides an input 202 to instruction 2 and an input 204 to instruction 3. Thus, instruction 3 may be executed as soon as it receives the input 204. In contrast, instruction 2 does not execute until it receives its other input 206 from instruction 3. Instruction 4 executes as soon as it receives an input 208 from instruction 2. Similarly, instruction 6 may be executed as soon as it receives an input 210 from instruction 5, while instruction 8 does not execute until it receives both the input 212 from instruction 6 and its other input 216 from instruction 7. Instruction 7 does not provide the input 216, however, until the input 214 is received from instruction 3.

To support such an execution approach, a Data Flow computer architecture employs a relatively large number of registers for each execution block. For example, a pair of registers may be temporarily allocated for each instruction in an execution block. In this way, once an operand for an instruction becomes available, it may be stored until any other operands for the instruction become available. Through the use of allocated registers for each instruction, the operands can be stored without affecting other instructions (and other blocks by extension).

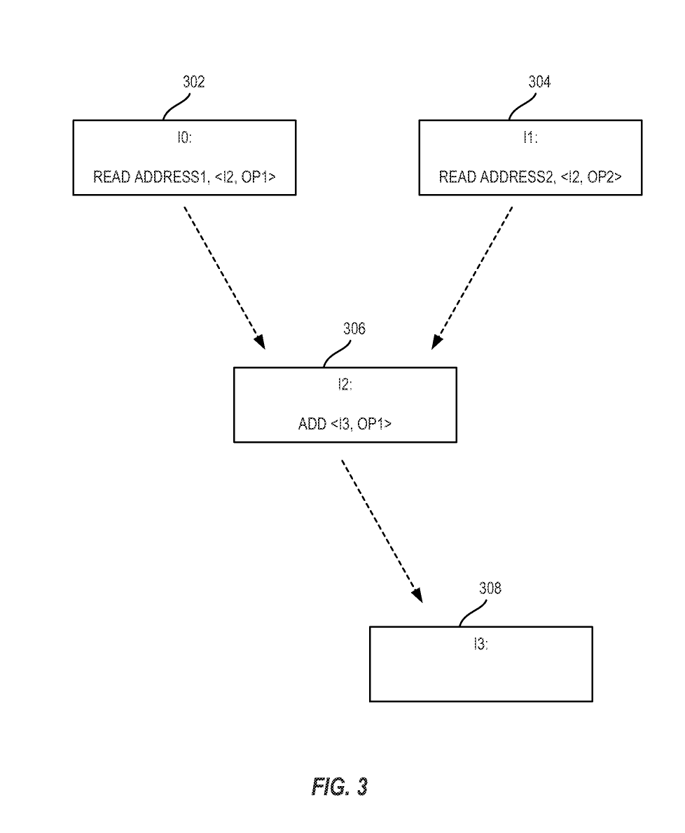

Thus, a Data Flow computer architecture may explicitly encode data dependencies between operations in machine instructions. For example, an EDGE architecture, such as Microsoft's E2, might use the (pseudo) instructions illustrated in FIG. 3 to add two values.

The first instruction 302, i0, reads a value from address1 in memory and dispatches the result to a third instruction 306, i2, as the first operand. Similarly, a second instruction 304, i1, reads a value from address2 and dispatches the result to instruction i2 as the second operand. When both operands arrive, the instruction i2 may perform the add operation and (in this case) send the result to a fourth instruction 308, i3.

As well as sending values to specified instructions, EDGE architectures often define one or more broadcast channels which may be used by a plurality of instructions to receive an operand. Stores and loads from registers are typically used to communicate values between different execution blocks. Thus, an EDGE architecture will pass data between execution blocks via registers, as well as memory pages.

### Taint Checking Mechanism

The disclosure relates in some aspects to a taint checking mechanism implemented within the register file, the instruction set, and the memory management of a Data Flow architecture such as an EDGE architecture. Instructions are collected into atomic blocks of, for example, up to 128 instructions. Instructions have 0, 1, 2, or more operands and explicitly send their results to 0, 1, 2, or more destinations. Destinations may include, without limitation, operands of other instructions in the same execution block, broadcast channels, or general purpose registers.

Each destination, regardless of type, stores the value it receives until it is used by all potential consuming instructions. This is achieved by mapping each destination (including named registers) in an implementation dependent way to a physical register in the register file.

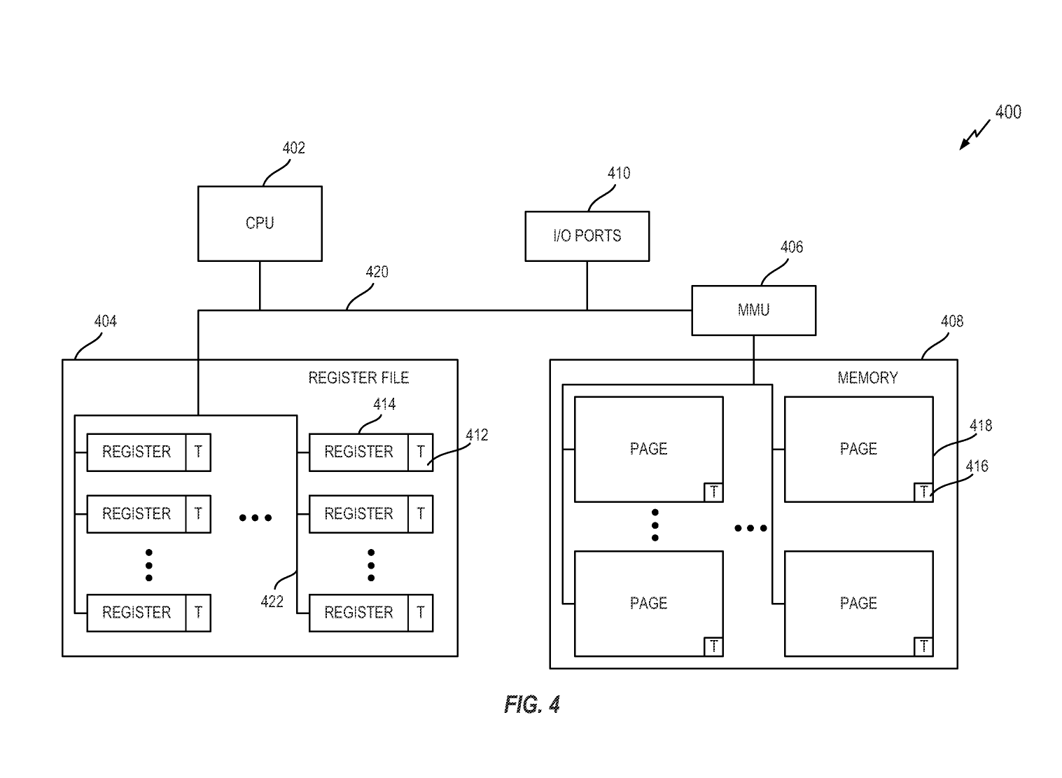

FIG. 4 illustrates a simplified example of a system 400 implementing such an architecture. The system 400 includes a CPU 402, a register file 404 including a large number of physical registers, a memory management unit (MMU) 406 that manages a physical memory 408 including a number of defined memory pages, and physical input/output (I/O) ports 410.

Various channels for communicating information between the components of the system are also illustrated in FIG. 4. For example, a channel (e.g., a signaling bus) 420 is used to communicate information between the CPU 402, the register file 404, the MMU 406 (and, hence, the memory 408), and the I/O ports 410. Also, a broadcast channel 422 can be employed to communicate information to and from the registers that implement this channel.

In accordance with the teachings herein, in some implementations, a taint flag is added to every physical register in the machine's register file. For example, a taint flag 412 (e.g., one bit) is indicated for one of the registers 414. In addition, in some implementations, the logic of every instruction executed by the CPU 402 is modified such that if any operand has its taint flag set, the taint flag is set on the destination.

Also in accordance with the teachings herein, in some implementations, a taint flag is also added to each page table entry managed by memory management unit hardware (typically in a translation look-aside buffer (TLB)). For example, a taint flag 416 (e.g., one bit) is indicated for one of the memory pages 418. If a memory read instruction accesses an address which intersects a page with the taint flag set, the taint flag is set on its destination.

If the taint flag is set on an operand to a memory store instruction and the memory address intersects with an untainted page, the page is marked as tainted. Alternatively, a trap instruction may be executed. Such a trap indicates a security exception that may be handled by the operating environment.

If the architecture supports specific I/O instructions, the destinations of all input instructions are flagged as tainted. Again, output instructions with tainted operands may cause a trap to be executed.

In accordance with the teachings herein, several instructions can be defined to support taint tracking. For example, two user mode instructions, TAINT and UNTAINT, can be defined. TAINT copies an operand to 0, 1, 2, etc., destinations and additionally sets their taint flags. UNTAINT operates similarly but unsets the taint flags of the destinations.

In addition, an additional user mode instruction, TAINTED, can be defined. This instruction generates a Boolean result: TRUE if the operand is tainted and FALSE otherwise.

Tainted values may be tracked in both direct and indirect addressing modes. In indirect addressing mode, a value in a register or memory can be used as an address of another value in memory. When a tainted value is used in such a mode to read memory, the values read are marked as tainted (even if the source page table entry is untainted). When used to write memory, the destination page table entry is marked as tainted.

Manipulation of taint flags in page tables and the TLB may be performed in supervisor mode as for all other MMU manipulations.

Through the use of the disclosed taint tracking mechanism, values which come from an external, and therefore potentially untrusted sources, can be tracked as they are manipulated by a program. Any attempt to use a tainted value in an unsafe way generates an exceptional condition which interrupts execution flow. Safe and unsafe data sources and sinks may be defined by marking memory pages appropriately. For instance, a kernel can ensure that only untainted values are passed to system calls by requiring parameters to be passed in untainted memory pages or registers.

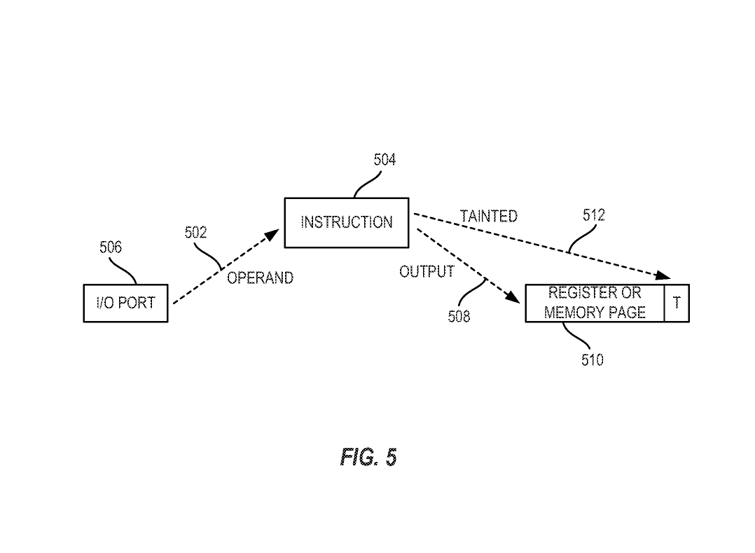

FIG. 5 illustrates an example of identifying a tainted value. Here, an operand 502 for an instruction 504 is read from an I/O port 506. The instruction 504 generates an output 508 based on the operand 502. Since data from the I/O port 506 is inherently not trusted, the taint flag T for the register or memory page 510 to which the output 508 is stored is set 512 to indicate that the stored value is tainted.

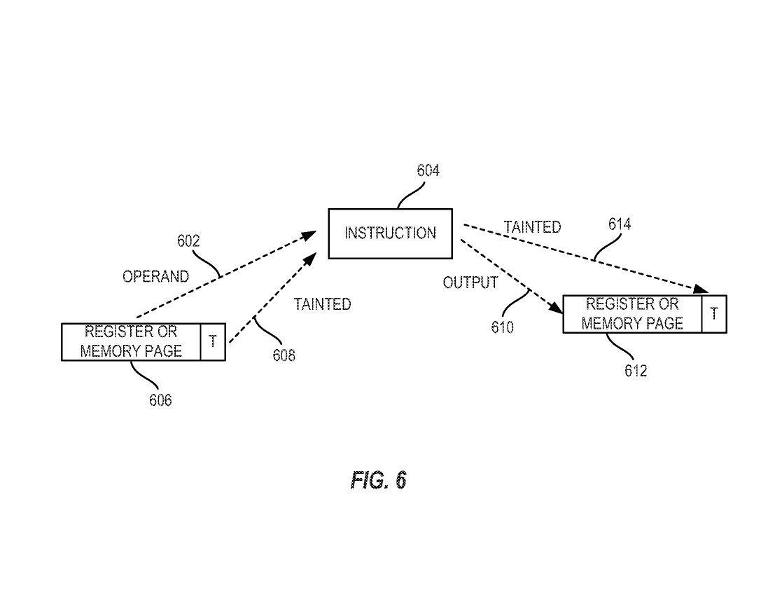

FIG. 6 illustrates an example of tracking a tainted value. Here, an operand 602 for an instruction 604 is read from a register or memory page 606. The taint flag T (assumed to be set) for the register or memory page 606 is also read 608. The instruction 604 generates an output 610 based on the operand 602 and stores the output 610 in another register or memory page 612. In addition, the taint flag T for the register or memory page 612 is set 614 to indicate that the stored value is tainted.

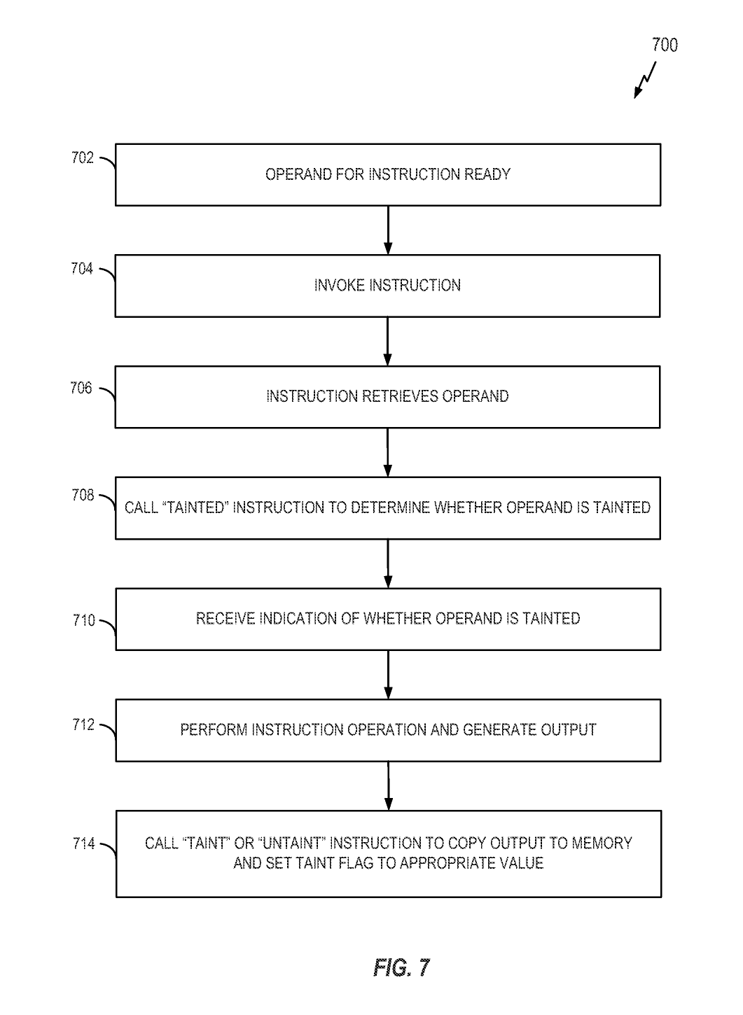

With the above in mind, several examples of operations that may be employed in accordance with the teachings herein will now be described with reference to FIGS. 7-9. For purposes of illustration, the operations of FIGS. 7-9 (or any other operations discussed or taught herein) may be described as being performed by specific components. However, these operations may be performed by other types of components and may be performed using a different number of components in other implementations. Also, it should be appreciated that one or more of the operations described herein may not be employed in a given implementation. For example, one entity may perform a subset of the operations and pass the result of those operations to another entity.

FIG. 7 illustrates several operations 700 that may be performed to track whether data is tainted.

At block 702, an operand (e.g., the only operand or last operand) for an instruction is ready. For example, the operand may have been output by another instruction.

At block 704, the instruction is invoked since each of its operands is available.

At block 706, the instruction retrieves (or otherwise acquires) the operand.

At block 708, the instruction calls another instruction (the TAINTED instruction) to determine whether the operand is tainted.

At block 710, the TAINTED instruction returns an indication of whether the operand is tainted to the calling instruction.

At block 712, the instruction operation is performed (e.g., an ADD operation or some other designated operation) and an output is generated.

At block 714, the instruction calls another instruction (the TAINT instruction or the UNTAINT instruction) to copy the output to memory (e.g., to a register or to a location in a memory page) and set the corresponding taint flag to the appropriate value (e.g., set or not set).

In a scenario where an instruction has several inputs (operands), operations similar to those described in FIG. 7 can be performed for each operand. In this case, when the last of these operands is ready (block 702), the instruction is invoked (block 704), whereupon the instruction retrieves each of these operands (block 706). For each operand, the “TAINTED” instruction is called to determine whether that operand is tainted (block 708). Accordingly, for each operand, an indication of whether the operand is tainted is received (block 710). The instruction operation is then performed and an output is generated (block 712). This output is copied to memory and the corresponding taint flag is set to the appropriate value (block 714). In this scenario, if any one of the operands is indicated as being tainted at block 710, the output is deemed tainted.

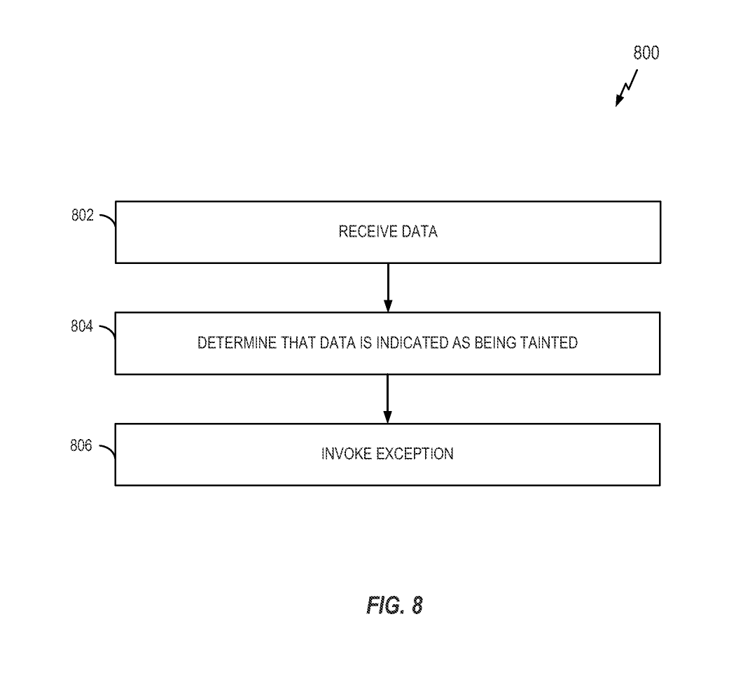

FIG. 8 illustrates several operations 800 that may be performed by a function or other operation upon receipt of tainted data. For example, the operations 800 may be performed by a kernel that handles a system call associated with a tainted operand.

At block 802, data is received.

At block 804, a determination is made that the data is indicated as being tainted. For example, the taint flag of a register that stores the data may be set.

At block 806, an exception is invoked. For example, a trap may be executed to prevent execution of any instructions associated with the tainted data.

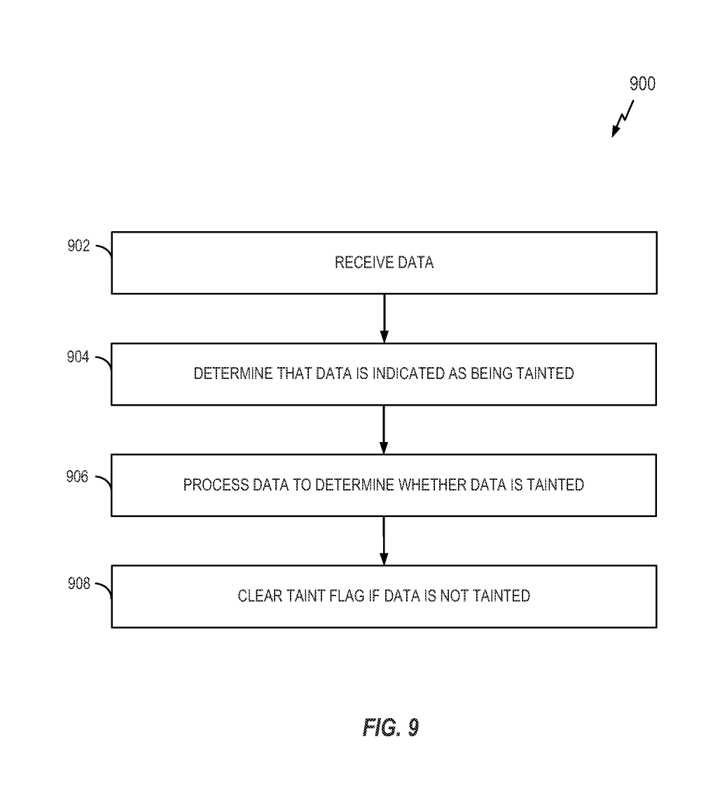

FIG. 9 illustrates several operations 900 that may be performed by a function or other operation to remove a taint indication for data. For example, the operations 900 may be performed by a process that is able to determine whether data is actually tainted.

At block 902, data is received.

At block 904, a determination is made that the data is indicated as being tainted. For example, the taint flag of a register that stores the data may be set.

At block 906, the data is processed to determine whether the data is actually tainted.

At block 908, the taint flag for the data is cleared if the data is not tainted.

### Example Electronic Device

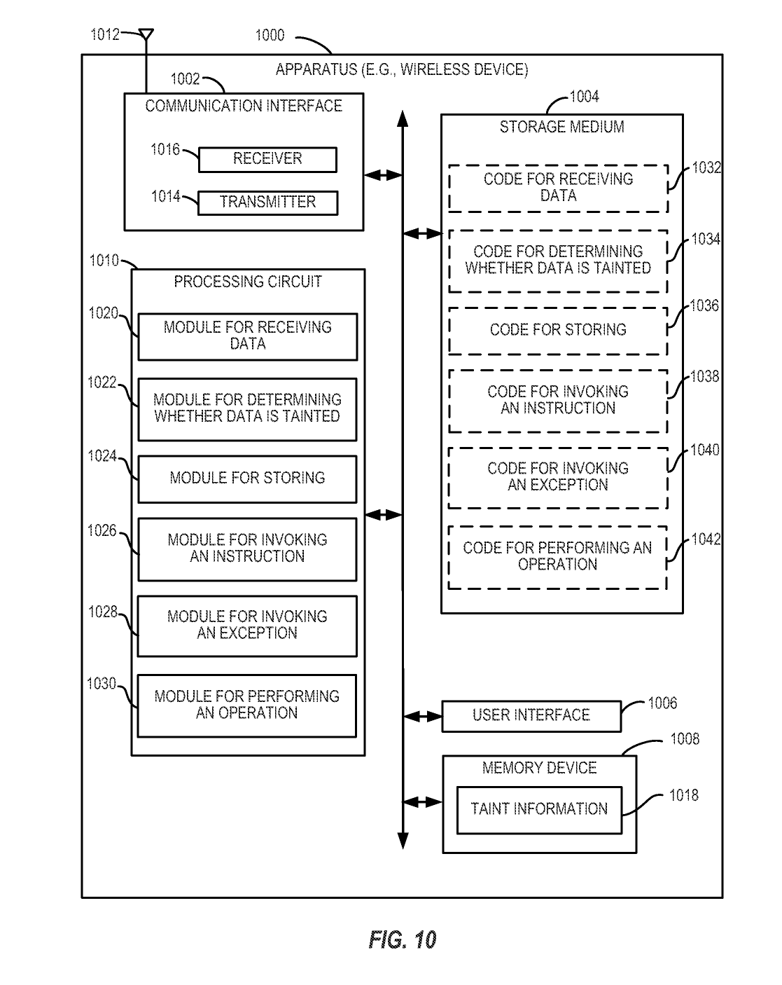

FIG. 10 is an illustration of an apparatus 1000 configured to support data tracking operations according to one or more aspects of the disclosure. The apparatus 1000 includes a communication interface 1002, a storage medium 1004, a user interface 1006, a memory device 1008, and a processing circuit 1010.

These components can be coupled to and/or placed in electrical communication with one another via a signaling bus or other suitable component, represented generally by the connection lines in FIG. 10. The signaling bus may include any number of interconnecting buses and bridges depending on the specific application of the processing circuit 1010 and the overall design constraints. The signaling bus links together various circuits such that each of the communication interface 1002, the storage medium 1004, the user interface 1006, and the memory device 1008 are coupled to and/or in electrical communication with the processing circuit 1010. The signaling bus may also link various other circuits (not shown) such as timing sources, peripherals, voltage regulators, and power management circuits, which are well known in the art, and therefore, will not be described any further.

The communication interface 1002 may be adapted to facilitate wireless or non-wireless communication of the apparatus 1000. For example, the communication interface 1002 may include circuitry and/or programming adapted to facilitate the communication of information bi-directionally with respect to one or more communication devices in a network. The communication interface 1002 may be coupled to one or more optional antennas 1012 for wireless communication within a wireless communication system. The communication interface 1002 can be configured with one or more standalone receivers and/or transmitters, as well as one or more transceivers. In the illustrated example, the communication interface 1002 includes a transmitter 1014 and a receiver 1016.

The memory device 1008 may represent one or more memory devices. As indicated, the memory device 1008 may maintain taint information 1018 along with other information used by the apparatus 1000. In some implementations, the memory device 1008 and the storage medium 1004 are implemented as a common memory component. The memory device 1008 may also be used for storing data that is manipulated by the processing circuit 1010 or some other component of the apparatus 1000.

The storage medium 1004 may represent one or more computer-readable, machine-readable, and/or processor-readable devices for storing programming, such as processor executable code or instructions (e.g., software, firmware), electronic data, databases, or other digital information. The storage medium 1004 may also be used for storing data that is manipulated by the processing circuit 1010 when executing programming. The storage medium 1004 may be any available media that can be accessed by a general purpose or special purpose processor, including portable or fixed storage devices, optical storage devices, and various other mediums capable of storing, containing or carrying programming.

By way of example and not limitation, the storage medium 1004 may include a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The storage medium 1004 may be embodied in an article of manufacture (e.g., a computer program product). By way of example, a computer program product may include a computer-readable medium in packaging materials. In view of the above, in some implementations, the storage medium 1004 may be a non-transitory (e.g., tangible) storage medium.

The storage medium 1004 may be coupled to the processing circuit 1010 such that the processing circuit 1010 can read information from, and write information to, the storage medium 1004. That is, the storage medium 1004 can be coupled to the processing circuit 1010 so that the storage medium 1004 is at least accessible by the processing circuit 1010, including examples where at least one storage medium is integral to the processing circuit 1010 and/or examples where at least one storage medium is separate from the processing circuit 1010 (e.g., resident in the apparatus 1000, external to the apparatus 1000, distributed across multiple entities, etc.).

Programming stored by the storage medium 1004, when executed by the processing circuit 1010, causes the processing circuit 1010 to perform one or more of the various functions and/or process operations described herein. For example, the storage medium 1004 may include operations configured for regulating operations at one or more hardware blocks of the processing circuit 1010, as well as to utilize the communication interface 1002 for wireless communication utilizing their respective communication protocols.

The processing circuit 1010 is generally adapted for processing, including the execution of such programming stored on the storage medium 1004. As used herein, the term “programming” shall be construed broadly to include without limitation instructions, instruction sets, data, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The processing circuit 1010 is arranged to obtain, process and/or send data, control data access and storage, issue commands, and control other desired operations. The processing circuit 1010 may include circuitry configured to implement desired programming provided by appropriate media in at least one example. For example, the processing circuit 1010 may be implemented as one or more processors, one or more controllers, and/or other structure configured to execute executable programming. Examples of the processing circuit 1010 may include a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may include a microprocessor, as well as any conventional processor, controller, microcontroller, or state machine. The processing circuit 1010 may also be implemented as a combination of computing components, such as a combination of a DSP and a microprocessor, a number of microprocessors, one or more microprocessors in conjunction with a DSP core, an ASIC and a microprocessor, or any other number of varying configurations. These examples of the processing circuit 1010 are for illustration and other suitable configurations within the scope of the disclosure are also contemplated.

According to one or more aspects of the disclosure, the processing circuit 1010 may be adapted to perform any or all of the features, processes, functions, operations and/or routines for any or all of the apparatuses described herein. As used herein, the term “adapted” in relation to the processing circuit 1010 may refer to the processing circuit 1010 being one or more of configured, employed, implemented, and/or programmed to perform a particular process, function, operation and/or routine according to various features described herein.

According to at least one example of the apparatus 1000, the processing circuit 1010 may include one or more of a module for receiving data 1020, a module for determining whether data is tainted 1022, a module for storing 1024, a module for invoking an instruction 1026, a module for invoking an exception 1028, and a module for performing an operation.

The module for receiving data 1020 may include circuitry and/or programming (e.g., code for receiving data 1032 stored on the storage medium 1004) adapted to perform several functions relating to, for example, receiving data from a physical memory location. In some implementations, the module for receiving data 1020 identifies a memory location of a value in the memory device 1008 and invokes a read of that location. The module for receiving data 1020 obtains the received data by, for example, obtaining this data directly from a component of the apparatus (e.g., the receiver 1016, the memory device 1008, or some other component). In some implementations, the module for receiving data 1020 processes the received information. The module for receiving data 1020 then outputs the received information (e.g., stores the information in the memory device 1008 or sends the information to another component of the apparatus 1000).

The module for determining whether data is tainted 1022 may include circuitry and/or programming (e.g., code for determining whether data is tainted 1034 stored on the storage medium 1004) adapted to perform several functions relating to, for example, reading a taint flag (or some other indicator) associated with a value stored in a physical data memory. Upon obtaining the flag or indicator, the module for determining whether data is tainted 1022 sends a corresponding indication to another component of the apparatus 1000).

The module for storing 1024 may include circuitry and/or programming (e.g., code for storing 1036 stored on the storage medium 1004) adapted to perform several functions relating to, for example, storing data and/or a taint indication in a physical memory location. Upon obtaining the data or indication (e.g., generated by an instruction), the module for storing 1024 passes the information to another component of the apparatus 1000 (e.g., stores the indication in the memory device 1008).

The module for invoking an instruction 1026 may include circuitry and/or programming (e.g., code for invoking an instruction 1038 stored on the storage medium 1004) adapted to perform several functions relating to, for example, invoking an instruction to determine whether data is tainted (e.g., invoking a TAINTED instruction) or invoking an instruction to store data and indication (e.g., invoking a TAINT instruction or an UNTAINT instruction). The module for invoking an instruction 1026 determines which instruction is to be invoked as well as any corresponding operands for the instruction. The module for invoking an instruction 1026 then causes the instruction to be executed (e.g., a kernel may invoke a system call).

The module for invoking an exception 1028 may include circuitry and/or programming (e.g., code for invoking an exception 1040 stored on the storage medium 1004) adapted to perform several functions relating to, for example, invoking an exception to stop execution associated with a tainted value. The module for invoking an exception 1028 determines that a received value is tainted. The module for invoking an exception 1028 then determines whether an instruction is to be invoked to cause an exception, as well as any corresponding operands for the instruction, if applicable. The module for invoking an exception 1028 subsequently causes the exception to be invoked (e.g., by setting a trap, or generating an interrupt signal).

The module for performing an operation 1030 may include circuitry and/or programming (e.g., code for performing an operation 1042 stored on the storage medium 1004) adapted to perform several functions relating to, for example, performing an operation to determine whether data is tainted. In some implementations, the module for performing an operation 1030 identifies a source of the data and determines whether the source is trustworthy. The module for performing an operation 1030 then generates an indication of whether the data is tainted and outputs the indication (e.g., stores the value in the memory device 1008 or sends the indication to another component of the apparatus 1000).

As mentioned above, programming stored by the storage medium 1004, when executed by the processing circuit 1010, causes the processing circuit 1010 to perform one or more of the various functions and/or process operations described herein. For example, the storage medium 1004 may include one or more of the code for receiving data 1032, the code for determining whether data is tainted 1034, the code for storing 1036, the code for invoking an instruction 1038, the code for invoking an exception 1040, and the code for performing an operation 1042.

### Example Processes

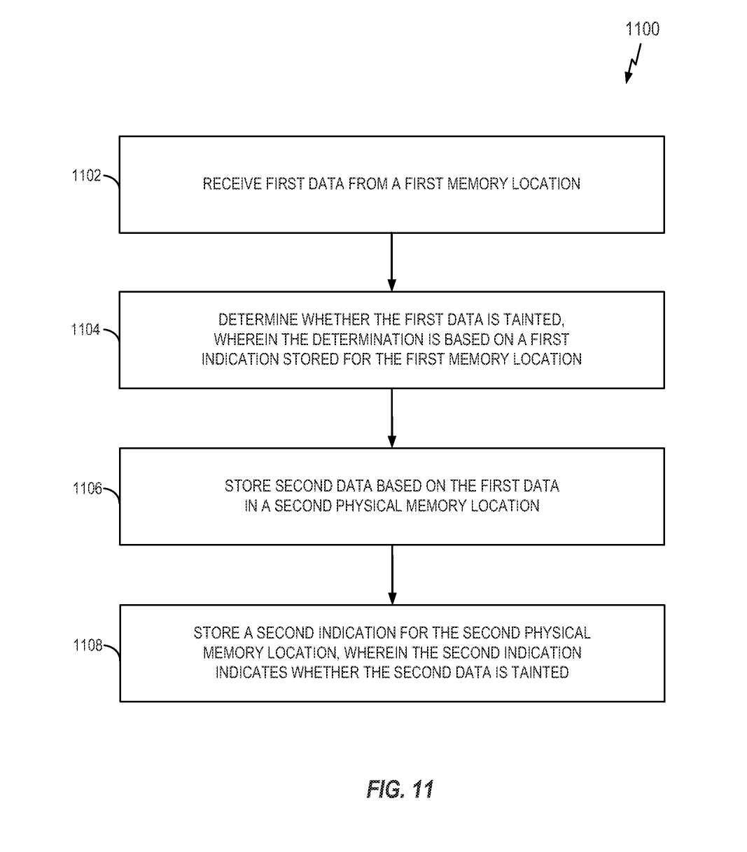

FIG. 11 illustrates a process 1100 for data tracking in accordance with some aspects of the disclosure. The process 1100 may take place within a processing circuit (e.g., the processing circuit 1010 of FIG. 10), which may be located in an electronic device or some other suitable apparatus. Of course, in various aspects within the scope of the disclosure, the process 1100 may be implemented by any suitable apparatus capable of supporting data tracking operations. In some aspects, the method is implemented in a Data Flow computer architecture (e.g., an EDGE architecture).

At block 1102, first data is received from a first memory location. In some aspects, the first physical memory location is a physical register, a page of a physical memory, or a physical input/output (I/O) port.

At block 1104, a determination is made as to whether the first data is tainted. This determination may be based on a first indication (e.g., a taint flag) stored for the first physical memory location.

At block 1106, second data based on the first data is stored in a second physical memory location. In some aspects, the second data has the same value as the first data. In some aspects, the second data is generated as a function of the first data.

At block 1108, a second indication for the second physical memory location is stored. The second indication indicates whether the second data is tainted.

In some aspects, the method is performed by a computer instruction. In this case, the first data may be an operand for the computer instruction and the second data may be an output of the computer instruction. In addition, in some aspects, the process 1100 further includes receiving a second operand for the computer instruction from a third physical memory location; determining whether the second operand is tainted, wherein the determination of whether the second operand is tainted is based on a third indication stored for the third physical memory location; and determining that the second data is tainted if at least one of the first and second operands is tainted.

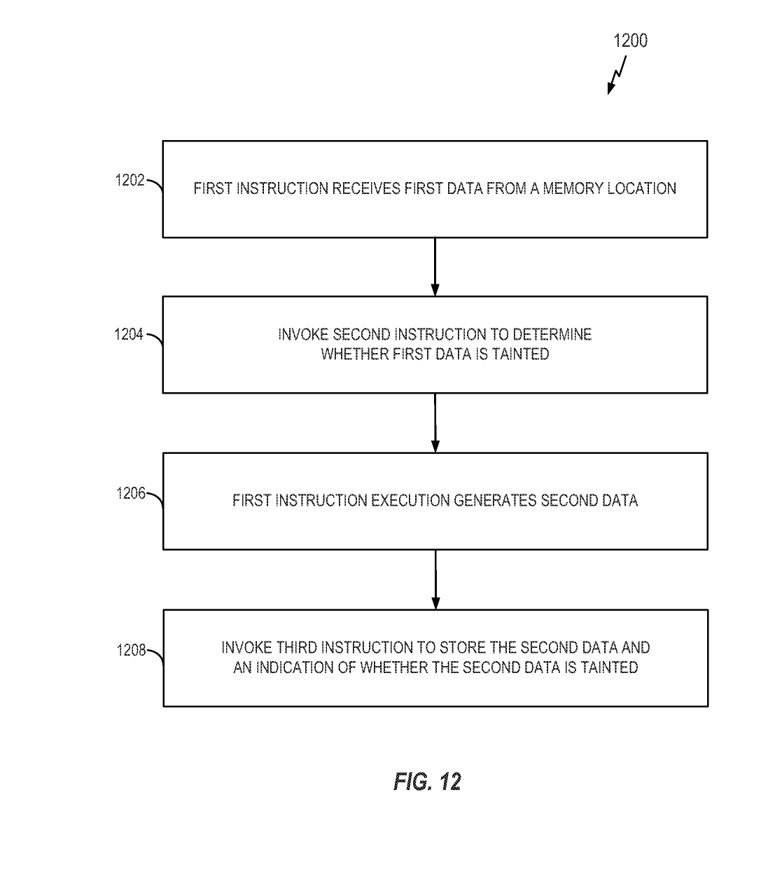

FIG. 12 illustrates a process 1200 for data tracking in accordance with some aspects of the disclosure. The process 1200 may take place within a processing circuit (e.g., the processing circuit 1010 of FIG. 10), which may be located in an electronic device or some other suitable apparatus. Of course, in various aspects within the scope of the disclosure, the process 1200 may be implemented by any suitable apparatus capable of supporting data tracking operations.

At block 1202, a first instruction receives first data from a memory location. In some aspects, the operation of block 1202 may correspond to the operation of block 1102 of FIG. 11.

At block 1204, a second instruction is invoked to determine whether the first data is tainted. For example, a TAINTED instruction may be invoked. In some aspects, the operation of block 1204 may correspond to the operation of block 1104 of FIG. 11.

At block 1206, execution of the first instruction causes second data to be generated. For example, the first instruction may generate an operand for another instruction.

At block 1208, a third instruction is invoked to store the second data and an indication of the whether the second data is tainted. For example, a TAINT instruction or an UNTAINT instruction may be invoked. In some aspects, the operation of block 1208 may correspond to the operation of blocks 1106 and 1108 of FIG. 11.

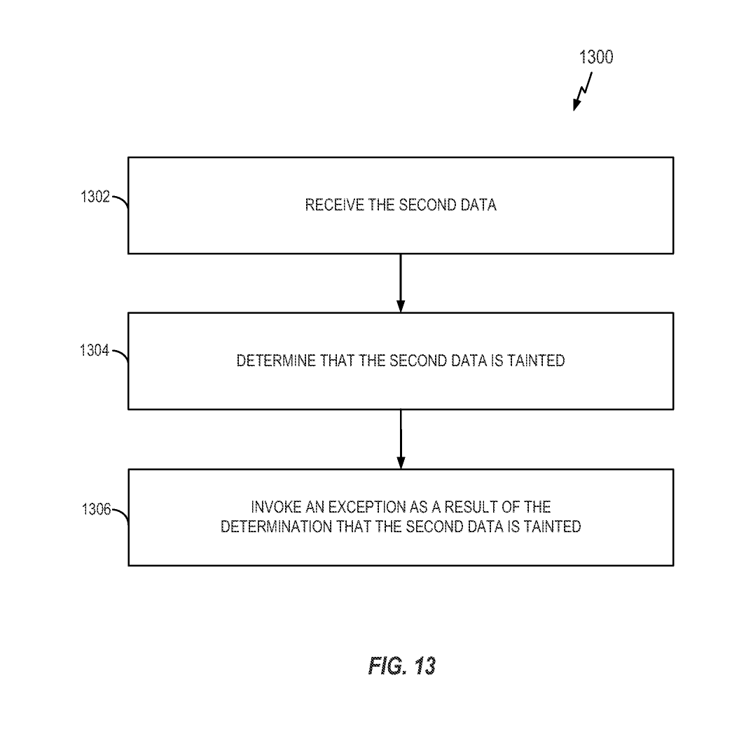

FIG. 13 illustrates a process 1300 for data tracking in accordance with some aspects of the disclosure. The process 1300 may take place within a processing circuit (e.g., the processing circuit 1010 of FIG. 10), which may be located in an electronic device or some other suitable apparatus. Of course, in various aspects within the scope of the disclosure, the process 1300 may be implemented by any suitable apparatus capable of supporting data tracking operations.

At block 1302, second data is received from a memory location. In some aspects, the operation of block 1302 may correspond to the operation of block 1102 of FIG. 11.

At block 1304, a determination is made as to whether the second data is tainted. For example, a TAINTED instruction may be invoked. In some aspects, the operation of block 1304 may correspond to the operation of block 1104 of FIG. 11.

At block 1306, an exception is invoked as a result of the determination that the second data is tainted. For example, a trap may be executed.

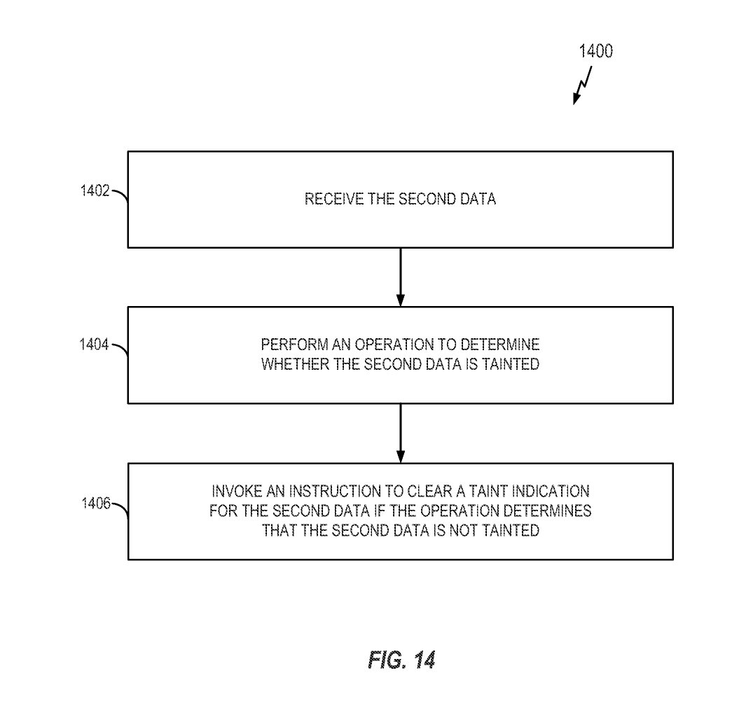

FIG. 14 illustrates a process 1400 for data tracking in accordance with some aspects of the disclosure. The process 1400 may take place within a processing circuit (e.g., the processing circuit 1010 of FIG. 10), which may be located in an electronic device or some other suitable apparatus. Of course, in various aspects within the scope of the disclosure, the process 1400 may be implemented by any suitable apparatus capable of supporting data tracking operations.

At block 1402, second data is received from a memory location. In some aspects, the operation of block 1402 may correspond to the operation of block 1102 of FIG. 11.

At block 1404, an operation is performed to determine whether the second data is tainted. For example, taint verification operations similar to those described above may be performed here.

At block 1406, if the operation of block 1404 determines that the second data is not tainted, an instruction is invoked to clear a taint indication (e.g., flag) for the second data.

### CONCLUSION

One or more of the components, steps, features and/or functions illustrated in the figures may be rearranged and/or combined into a single component, step, feature or function or embodied in several components, steps, or functions. Additional elements, components, steps, and/or functions may also be added without departing from novel features disclosed herein. The apparatus, devices, and/or components illustrated in the figures may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein. Additional elements, components, steps, and/or functions may also be added or not utilized without departing from the disclosure.

While features of the disclosure may have been discussed relative to certain implementations and figures, all implementations of the disclosure can include one or more of the advantageous features discussed herein. In other words, while one or more implementations may have been discussed as having certain advantageous features, one or more of such features may also be used in accordance with any of the various implementations discussed herein. In similar fashion, while exemplary implementations may have been discussed herein as device, system, or method implementations, it should be understood that such exemplary implementations can be implemented in various devices, systems, and methods.

Also, it is noted that at least some implementations have been described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. In some aspects, a process may correspond to a method, a function, a procedure, a subroutine, a subprogram, etc. When a process corresponds to a function, its termination corresponds to a return of the function to the calling function or the main function. One or more of the various methods described herein may be partially or fully implemented by programming (e.g., instructions and/or data) that may be stored in a machine-readable, computer-readable, and/or processor-readable storage medium, and executed by one or more processors, machines and/or devices.

Those of skill in the art would further appreciate that the various illustrative logical blocks, modules, circuits, and algorithm steps described in connection with the implementations disclosed herein may be implemented as hardware, software, firmware, middleware, microcode, or any combination thereof. To clearly illustrate this interchangeability, various illustrative components, blocks, modules, circuits, and steps have been described above generally in terms of their functionality. Whether such functionality is implemented as hardware or software depends upon the particular application and design constraints imposed on the overall system.

Within the disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first die may be coupled to a second die in a package even though the first die is never directly physically in contact with the second die. The terms “circuit” and “circuitry” are used broadly, and intended to include both hardware implementations of electrical devices and conductors that, when connected and configured, enable the performance of the functions described in the disclosure, without limitation as to the type of electronic circuits, as well as software implementations of information and instructions that, when executed by a processor, enable the performance of the functions described in the disclosure.

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

Accordingly, the various features associate with the examples described herein and shown in the accompanying drawings can be implemented in different examples and implementations without departing from the scope of the disclosure. Therefore, although certain specific constructions and arrangements have been described and shown in the accompanying drawings, such implementations are merely illustrative and not restrictive of the scope of the disclosure, since various other additions and modifications to, and deletions from, the described implementations will be apparent to one of ordinary skill in the art. Thus, the scope of the disclosure is only determined by the literal language, and legal equivalents, of the claims which follow.

What is claimed is:

1. A method for data management, comprising:
receiving first data from a first physical memory location;
determining whether the first data is tainted, wherein the determination is based on a first indication stored for the first physical memory location;
storing second data based on the first data in a second physical memory location; and
storing a second indication for the second physical memory location, wherein the second indication indicates whether the second data is tainted.

2. The method of claim 1, wherein the method is implemented in a Data Flow computer architecture.

3. The method of claim 2, wherein the Data Flow computer architecture is an Explicit Data Graph Execution (EDGE) architecture.

4. The method of claim 1, wherein the second data has the same value as the first data or the second data is generated as a function of the first data.

5. The method of claim 1, wherein the first and second physical memory locations comprise at least one of: a physical register, a page of a physical memory, or a physical input/output (I/O) port.

6. The method of claim 1, further comprising invoking an instruction to determine whether the first data is tainted.

7. The method of claim 1, further comprising invoking an instruction to store the second data and the second indication.

8. The method of claim 1, wherein:
the method is performed by a computer instruction;
the first data comprises a first operand for the computer instruction; and
the second data comprises an output of the computer instruction.

9. The method of claim 8, further comprising:
receiving a second operand for the computer instruction from a third physical memory location;
determining whether the second operand is tainted, wherein the determination of whether the second operand is tainted is based on a third indication stored for the third physical memory location; and
determining that the second data is tainted if at least one of the first and second operands is tainted.

10. The method of claim 1, further comprising:
receiving the second data;
determining that the second data is tainted; and
invoking an exception as a result of the determination that the second data is tainted.

11. The method of claim 1, further comprising:
receiving the second data;
performing an operation to determine whether the second data is tainted; and
invoking an instruction to clear a taint indication for the second data if the operation determines that the second data is not tainted.

12. An apparatus for data management, comprising:
at least one memory circuit; and
a processing circuit coupled to the at least one memory circuit and configured to:
receive first data from a first physical memory location of the at least one memory circuit;
determine whether the first data is tainted, wherein the determination is based on a first indication stored for the first physical memory location;
store second data based on the first data in a second physical memory location of the at least one memory circuit; and
store a second indication for the second physical memory location, wherein the second indication indicates whether the second data is tainted.

13. The apparatus of claim 12, wherein the apparatus is implemented in a Data Flow computer architecture.

14. The apparatus of claim 13, wherein the Data Flow computer architecture is an Explicit Data Graph Execution (EDGE) architecture.

15. The apparatus of claim 12, wherein the second data has the same value as the first data or the second data is generated as a function of the first data.

16. The apparatus of claim 12, wherein the first and second physical memory locations comprise at least one of: a physical register, a page of a physical memory, or a physical input/output (I/O) port.

17. The apparatus of claim 12, wherein the processing circuit is further configured to invoke an instruction to determine whether the first data is tainted.

18. The apparatus of claim 12, wherein the processing circuit is further configured to invoke an instruction to store the second data and the second indication.

19. The apparatus of claim 12, wherein:
the processing circuit is further configured to execute a computer instruction;
the first data comprises an operand for the computer instruction; and
the second data comprises an output of the computer instruction.

20. The apparatus of claim 12, wherein the processing circuit is further configured to:
receive the second data;
determine that the second data is tainted; and
invoke an exception as a result of the determination that the second data is tainted.

21. The apparatus of claim 12, wherein the processing circuit is further configured to:
receive the second data;
perform an operation to determine whether the second data is tainted; and
invoke an instruction to clear a taint indication for the second data if the operation determines that the second data is not tainted.

22. An apparatus for data management, comprising:
means for receiving first data from a first physical memory location;
means for determining whether the first data is tainted, wherein the determination is based on a first indication stored for the first physical memory location;
means for storing second data based on the first data in a second physical memory location; and
means for storing a second indication for the second physical memory location, wherein the second indication indicates whether the second data is tainted.

23. The apparatus of claim 22, wherein the apparatus is implemented in an Explicit Data Graph Execution (EDGE) architecture.

24. The apparatus of claim 22, wherein the first and second physical memory locations comprise at least one of: a physical register, a page of a physical memory, or a physical input/output (I/O) port.

25. The apparatus of claim 22, further comprising means for invoking an instruction to determine whether the first data is tainted.

26. The apparatus of claim 22, further comprising means for invoking an instruction to store the second data and the second indication.

27. A non-transitory computer-readable medium storing computer executable code, including code to:
receive first data from a first physical memory location;
determine whether the first data is tainted, wherein the determination is based on a first indication stored for the first physical memory location;
store second data based on the first data in a second physical memory location; and
store a second indication for the second physical memory location, wherein the second indication indicates whether the second data is tainted.

28. The computer-readable medium of claim 27, wherein the code is for an Explicit Data Graph Execution (EDGE) architecture.

29. The computer-readable medium of claim 27, wherein the first and second physical memory locations comprise at least one of: a physical register, a page of a physical memory, or a physical input/output (I/O) port.

30. The computer-readable medium of claim 27, further comprising code to invoke an instruction to determine whether the first data is tainted.
